(19) United States
(12) Patent Application Publication
(10) Pub. No.: US 2010/0120569 A1
(43) Pub. Date: May 13, 2010

(54) DRIVING APPARATUS FOR HYBRID VEHICLE

(75) Inventors: Hiroaki Sanji, Anjo (JP); Natsuki Sada, Anjo (JP); Tomoo Atarashi, Kariya (JP); Michitaka Tsuchida, Miyoshi (JP); Hideaki Komada, Gotenba (JP)

Correspondence Address: OLIFF & BERRIDGE, PLC, P.O. BOX 320850, ALEXANDRIA, VA, 22320-4850, US

(73) Assignees: Aisin AW Co., Ltd., Anjo-shi (JP); Toyota Jidosha Kabushiki Kaisha, Toyota-Shi (JP)

(21) Appl. No.: 12/451,937

(22) PCT Filed: Jul. 14, 2008
(86) PCT No.: PCT/JP2008/062677

§ 371 Date: Dec. 8, 2009

(30) Foreign Application Priority Data
Jul. 18, 2007 (JP) 2007-186857

(51) Int. Cl. B60K 6/365

(52) U.S. Cl. 475/5; 180/65.235

(57) ABSTRACT

A driving apparatus for a hybrid vehicle that includes an input shaft linked to an engine; a generator; a motor; a differential gear device including a first gear element linked to a rotary shaft of the generator, a second gear element linked to the input shaft, and a third gear element that transmits power to a drive shaft; and a counter gear that is linked to the third gear element of the differential gear device and drive-linked to the motor.

### CROSS-REFERENCE TO RELATED APPLICATION

This application is the U.S. National Phase of PCT/JP2008/062677 filed Jul. 14, 2008, which claims priority from Japanese Patent Application No. 2007-186857 filed Jul. 18, 2007, the disclosures of which are incorporated herein by reference in their entirety.

### BACKGROUND

The present invention relates to a driving apparatus installed in a hybrid vehicle that uses an engine and a motor as drive sources.

In a driving apparatus for a hybrid vehicle that uses an engine (an internal combustion engine) and a motor as drive sources, power from two systems must be transmitted to a drive shaft connected to a drive wheel via a differential device, and various constructions have been proposed as a power train constitution used for this purpose. One of these constructions, for example, is a vehicle driving apparatus in which a generator, a power splitting planetary gear mechanism, a motor speed reducing planetary gear mechanism, and a motor are disposed coaxially with an input shaft (an output shaft of an engine) in this order from the engine side (Japanese Patent Application Publication No. 2006-298314). In this vehicle driving apparatus, power from the engine and power from the motor with the torque being amplified by the motor speed reducing planetary gear mechanism are synthesized by a counter gear portion so that the resulting synthesized torque can be transmitted to a drive shaft via a differential device.

### SUMMARY

However, in the vehicle driving apparatus described above, the overall physical constitution of the driving apparatus is large, leading to an increase in cost. The reason for this is that since the generator, the power splitting planetary gear mechanism, the motor speed reducing planetary gear mechanism, and the motor are disposed coaxially, an axial dimension of the driving apparatus increases in length, and therefore a bearing of the motor is disposed in a space on the inner periphery of the motor (an inner side of a coil) in order to reduce the axial length of the driving apparatus. In other words, the bearing is disposed inside the motor. As a result, the size of the motor in a radial direction increases, leading to an increase in the overall physical constitution of the driving apparatus.

Further, the motor speed reducing planetary gear mechanism is used to transmit the power of the motor to the counter gear portion by amplifying the torque. In other words, a planetary gear mechanism is used to reduce rotation of the motor. As a result, the cost of the driving apparatus increases. Moreover, there is a limit to the magnitude of a reduction ratio of the planetary gear mechanism that can be set relative to its size, and therefore high performance is required of the motor, leading to increases in the physical constitution and cost of the motor. As a result, the overall physical constitution of the driving apparatus increases, leading to an increase in the cost.

The present invention has been designed to solve the problems described above, and it is an object of the present invention to provide a driving apparatus for a hybrid vehicle in which the overall size and cost of the driving apparatus can be reduced.

A driving apparatus for a hybrid vehicle according to the present invention, which has been designed to solve the problems described above, includes: an input shaft linked to an engine; a generator; a motor; a differential gear device including a first gear element linked to a rotary shaft of the generator, a second gear element linked to the input shaft, and a third gear element that transmits power to a drive shaft; and a counter gear that is linked to the third gear element of the differential gear device and drive-linked to the motor. In the driving apparatus, the generator, the differential gear device, and the counter gear are disposed coaxially with the input shaft, the motor is disposed on a different axis parallel to the input shaft on an opposite side of the generator, the differential gear device, and the counter gear to an engine-linked side of the input shaft in an axial direction, motor bearings for rotatably supporting a rotary shaft of the motor are disposed on an outer side of the motor, the motor is disposed to overlap at least one of first axis constitutional components disposed coaxially with the input shaft in a radial direction, and a differential gear device side bearing of the motor bearings, which is positioned on the differential gear device side, is disposed to overlap at least one of the first axis constitutional components in the axial direction.

Note that the first axis constitutional components include, in addition to the generator, the differential gear device, the counter gear, and the input shaft, all constitutional components of the driving apparatus (an oil pump, bearings, and so on, for example) disposed coaxially with the input shaft (on a first axis) and components required to disposed these components (cases of the components, fixing members of the components such as bolts and nuts, and so on, for example).

In this driving apparatus for a hybrid vehicle, the motor is disposed on a different axis parallel to the input shaft on the opposite side of the generator, differential gear device, and counter gear to the engine-linked side of the input shaft in the axial direction, and therefore the rotation of the motor can be reduced using a spur gear or a helical gear instead of a planetary gear mechanism. In other words, the rotation of the motor can be reduced using the counter gear for transmitting power to the drive shaft (i.e. by transmitting the rotation of the motor to the counter gear via a smaller gear than the counter gear). In so doing, a larger reduction ratio than that of a planetary gear mechanism can be used, and therefore high performance is no longer required of the motor. Accordingly, the size and cost of the motor can be reduced. Furthermore, since a planetary gear mechanism is not required to reduce the rotation of the motor, the size of the driving apparatus in the axial direction can be reduced, thereby reducing the cost.

Further, the motor bearings are disposed on the outside of the motor, and therefore the size of the motor in the radial direction can be reduced. Furthermore, the motor is disposed so as to overlap at least one of the first axis constitutional components in the radial direction, and therefore the motor shaft can be brought closer to the first axis. As a result, increases in the size of the driving apparatus in the radial direction when the motor is disposed on a different axis from the input shaft can be minimized.

Moreover, the differential gear device side bearing of the motor bearings, which is positioned on the differential gear device side, is disposed to overlap the first axis constitutional components in the axial direction, and therefore, even when the motor bearings are disposed on the outside of the motor, the axial length of the driving apparatus is not affected. In other words, the axial size of the driving apparatus can be sufficiently reduced by eliminating the need for a planetary gear mechanism to reduce the rotation of the motor.

Hence, with the driving apparatus for a hybrid vehicle according to the present invention, the size and cost of the motor can be reduced, and the rotation of the motor can be reduced using the counter gear instead of a planetary gear mechanism. Therefore, the overall size and cost of the driving apparatus can be reduced.

In the driving apparatus for a hybrid vehicle according to the present invention, the generator, the differential gear device, and the counter gear are preferably disposed coaxially with the input shaft in this order from the engine-linked side of the input shaft, and an output shaft of the motor preferably overlaps the generator in the radial direction.

With this constitution, the motor and counter gear can be disposed close to each other, and the output shaft of the motor can be prevented from overlapping the generator, which has a large radial dimension, in the axial direction. As a result, the length of the output shaft of the motor can be shortened, thereby reducing the cost and further reducing the radial size of the driving apparatus.

In the driving apparatus for a hybrid vehicle according to the present invention, one of the first axis constitutional components that overlaps the motor bearings in the axial direction is preferably an oil pump.

By overlapping the oil pump, which has a small radial dimension, with the motor bearings in the axial direction in this manner, the radial size of the driving apparatus can further be reduced.

In the driving apparatus for a hybrid vehicle according to the present invention, the generator, the differential gear device, the counter gear, and the oil pump are preferably disposed coaxially with the input shaft in this order from the engine-linked side of the input shaft.

With this constitution, the motor and counter gear can be disposed close to each other, and the motor bearings can be overlapped with the oil pump, which has a small radial dimension, in the axial direction. As a result, the length of the output shaft of the motor can be shortened, thereby reducing the cost and further reducing the radial size of the driving apparatus.

In the driving apparatus for a hybrid vehicle according to the present invention, the oil pump is preferably disposed on a terminal end portion of the input shaft and driven by a rotation of the input shaft.

By disposing the oil pump on the terminal end portion of the input shaft in this manner such that the oil pump is driven directly by the input shaft, the need for a new mechanism to drive the oil pump is eliminated, and therefore the axial length of the first axis can be shortened, thereby reducing the cost. As a result, the axial size and cost of the driving apparatus can further be reduced.

In the driving apparatus for a hybrid vehicle according to the present invention, the drive shaft is preferably disposed parallel to the input shaft, an output gear of the motor preferably meshes with the counter gear, the counter gear is preferably disposed parallel to the input shaft so as to mesh with a counter driven gear of a counter shaft that transmits power to the drive shaft, and a final drive pinion gear of the counter shaft preferably meshes with a final ring gear of a differential device that transmits power to the drive shaft.

Hence, the single counter gear can serve as a speed reducing mechanism of the motor and a gear for transmitting power from the input shaft to the drive shaft, and therefore the need to provide a separate speed reducing mechanism for reducing the rotation of the motor is eliminated. Accordingly, a dedicated space for disposing a speed reducing mechanism is not required, and therefore the axial size of the driving apparatus can be reduced.

In the driving apparatus for a hybrid vehicle according to the present invention, an oil pump gear chamber that accommodates an oil pump gear mechanism provided in the oil pump is preferably formed integrally with a motor case that accommodates and supports the motor.

Further, the oil pump gear chamber is preferably provided in a first extension portion extending such that the motor case partially surrounds the oil pump gear mechanism.

By forming the gear chamber that accommodates the oil pump gear mechanism in the motor case in this manner, the motor case and a casing of the oil pump can be formed integrally. As a result, the oil pump and the motor can be disposed close to each other in the axial direction. Hence, the axial length of the driving apparatus can be shortened even further, thereby further reducing the overall size of the driving apparatus.

Moreover, since the motor case and the casing of the oil pump are formed integrally, the number of components is reduced, thereby reducing the number of assembly processing steps correspondingly. As a result, the cost of the driving apparatus can be further reduced.

In the driving apparatus for a hybrid vehicle according to the present invention, an oil pump cover that closes an opening in the oil pump gear chamber is preferably fixed to the motor case by a snap ring.

By fixing the oil pump cover to the motor case by a snap ring in this manner, a bolt is not used to fix the oil pump cover, in contrast to a conventional driving apparatus, and therefore, since a bolt head does not exist, the need to secure space for disposing the bolt head is eliminated. As a result, the oil pump and the gear mechanism (the differential gear device and the counter gear) of the driving apparatus can be disposed close to each other in the axial direction. Hence, the axial length of the driving apparatus can be shortened even further, thereby further reducing the overall size of the driving apparatus.

In the driving apparatus for a hybrid vehicle according to the present invention, a bearing holding portion for holding a counter gear bearing that rotatably supports the counter gear is preferably formed integrally with the motor case that accommodates and supports the motor.

By forming the bearing holding portion for holding the counter gear bearing on the motor case in this manner, the motor case and bearing holding portion can be formed integrally. As a result, the counter gear and motor can be disposed close to each other in the axial direction. Hence, the axial length of the driving apparatus can be shortened even further, thereby further reducing the overall size of the driving apparatus.

Moreover, since the motor case and the bearing holding portion are formed integrally, the number of components is reduced, thereby reducing the number of assembly processing steps correspondingly. As a result, the cost of the driving apparatus can further be reduced.

Further, the bearing holding portion is preferably provided in a second extension portion formed to further extend from the first extension portion, which extends such that the motor case partially surrounds the oil pump gear mechanism provided in the oil pump, so as to surround a boss portion of the counter gear.

By providing the bearing holding portion in the second extension portion that further extends from the first extension portion in this manner, the oil pump and counter gear can be disposed even closer to each other in the axial direction. As a result, the motor, the oil pump, and the gear mechanism (the differential gear device and the counter gear) can be disposed closer to each other in the axial direction. Hence, the axial length of the driving apparatus can be shortened even further, thereby further reducing the overall size of the driving apparatus.

In the driving apparatus for a hybrid vehicle according to the present invention, in a vehicle installed state, the motor is preferably disposed such that the rotary shaft of the motor is positioned between the input shaft and the drive shaft in a vehicle front-rear direction and above the input shaft.

By disposing the motor in this manner, an empty space between the input shaft and the drive shaft can be used, and therefore the size of the driving apparatus can be reduced while preventing reduction in the minimum ground clearance of the vehicle.

With the driving apparatus for a hybrid vehicle according to the present invention, as described above, the overall size and cost of the driving apparatus can be reduced.

### BRIEF DESCRIPTION OF THE DRAWINGS

FIG. 1 is a skeleton diagram of a driving apparatus according to an embodiment.

FIG. 2 is a schematic sectional view showing the constitution of the driving apparatus according to the embodiment.

FIG. 3 is an enlarged sectional view of the vicinity of an oil pump.

FIG. 4 is a diagram showing arrangement relationships among various components provided in the driving apparatus according to the embodiment.

### DETAILED DESCRIPTION OF EMBODIMENTS

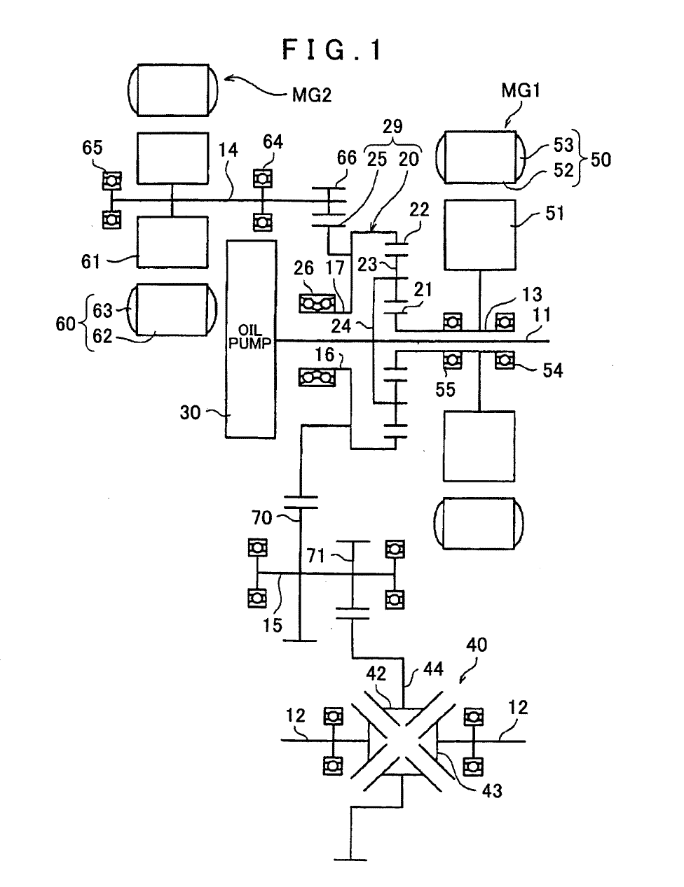

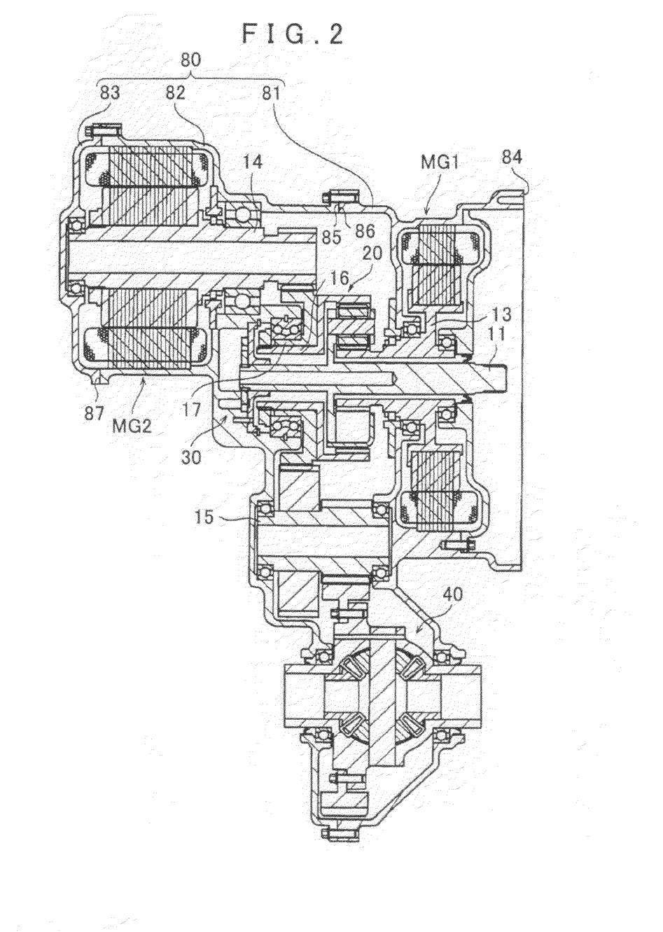

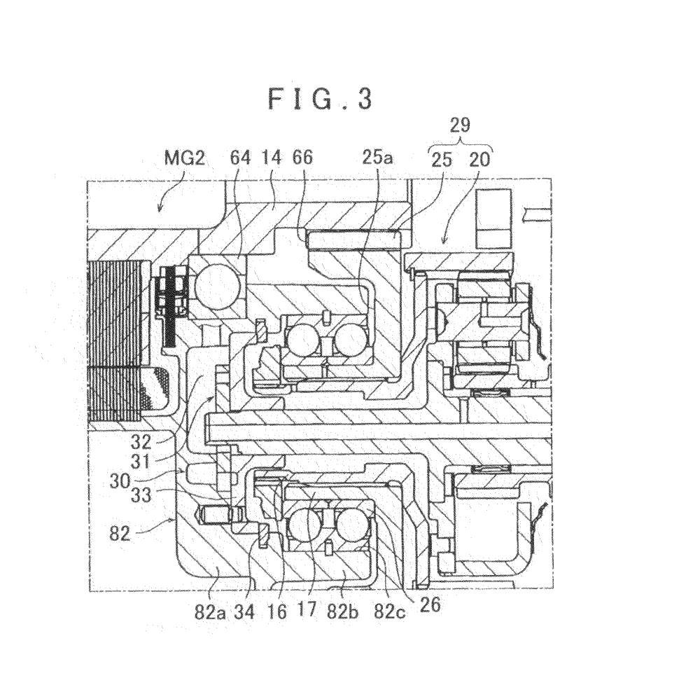

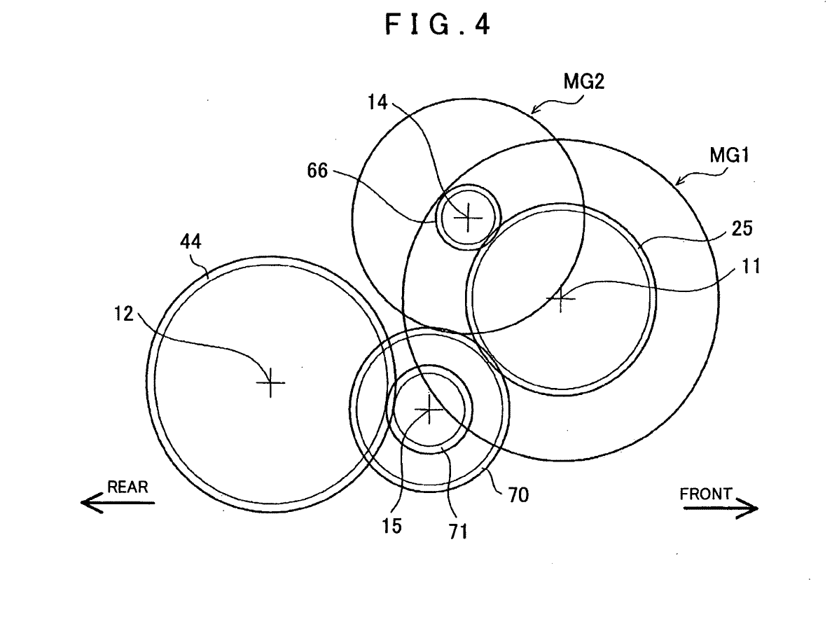

A most preferred embodiment of a driving apparatus for a hybrid vehicle according to the present invention will be described in detail below with reference to the drawings. The present embodiment relates to a transverse driving apparatus installed in a front engine/front drive (FF) vehicle. The driving apparatus according to the present embodiment will now be described with reference to FIGS. 1 to 4. FIG. 1 is a skeleton diagram of the driving apparatus according to the present embodiment. FIG. 2 is a schematic sectional view showing the constitution of the driving apparatus according to the present embodiment. FIG. 3 is an enlarged sectional view of the vicinity of an oil pump. FIG. 4 is a diagram showing arrangement relationships among various components provided in the driving apparatus according to the present embodiment.

As shown in FIG. 1, the driving apparatus according to the present embodiment includes an input shaft 11 into which power from an engine (not shown) is input, a motor/generator MG1, a motor/generator MG2, a differential gear device 20 to which the motor/generator MG1, the motor/generator MG2, and the input shaft 11 are connected, an oil pump 30 connected to the input shaft 11, and a differential device 40 connected to the differential gear device 20. Thus, power from the engine and power from the motor/generator MG2 can be transmitted to a drive shaft 12 connected to a drive wheel via the differential gear device 20 and the differential device 40.

The input shaft 11 is disposed coaxially (on a first axis) with a crankshaft (not shown) of the engine such that the power from the engine (not shown) is transmitted to the input shaft 11 via a damper mechanism (not shown). The motor/generator MG1 is disposed coaxially with the input shaft 11, in other words, on the first axis. The motor/generator MG1 functions as a motor driven by a power supply (a motoring function) and as a generator that converts mechanical energy into electrical energy (a regenerating function). The motor/generator MG1 operates mainly as a generator, but is also used as a starter of the engine. An alternating current synchronous motor/generator, for example, may be used as the motor/generator MG1. A storage device such as a battery or a capacitor and a well-known fuel cell, for example, may be used as a power supply device for supplying power to the motor/generator MG1. Note that the motor/generator MG1 according to the present embodiment corresponds to a “generator” of the present invention.

The motor/generator MG1 includes a stator 50 fixed to a transaxle case 80, to be described below, and a rotatable rotor 51. The stator 50 includes a stator core 52 and a coil 53 wound around the stator core 52. The rotor 51 and the stator core 52 are respectively formed by stacking a plurality of magnetic steel sheets of a predetermined thickness in a thickness direction. Note that the plurality of magnetic steel sheets are stacked in an axial direction of the input shaft 11. A rotor shaft 13 is disposed in the center of the rotor 51 such that the rotor 51 and the rotor shaft 13 are linked. As a result, the rotor 51 and the rotor shaft 13 rotate integrally. The rotor shaft 13 is a hollow shaft, and the input shaft 11 is disposed inside the rotor shaft 13. The input shaft 11 and rotor shaft 13 are constituted to be rotatable relative to each other. Bearings 54, 55 supporting the rotor shaft 13 are disposed in an inner space of the rotor 51. Note that the rotor shaft 13 according to the present embodiment corresponds to a “rotary shaft of the generator” of the present invention.

The differential gear device 20 is disposed coaxially with the motor/generator MG1, i.e. coaxially with the input shaft 11. In other words, the differential gear device 20 is also provided on the first axis. The differential gear device 20 is disposed adjacent to the motor/generator MG1 in the axial direction of the input shaft 11. The differential gear device 20 is constituted by a so-called single pinion planetary gear set. More specifically, the differential gear device 20 includes a sun gear 21, a ring gear 22 disposed coaxially with the sun gear 21, and a planetary carrier 24 supporting a planetary pinion gear 23 that meshes with the sun gear 21 and ring gear 22. The sun gear 21 is linked to the rotor shaft 13, and the planetary carrier 24 is linked to the input shaft 11. Further, a counter gear 25 is linked to the ring gear 22. The counter gear 25 and the differential gear device 20 together constitute a gear mechanism 29. Note that the sun gear 21 according to the present embodiment corresponds to a “first gear element” of the present invention, the planetary carrier 24 corresponds to a “second gear element” of the present invention, and the ring gear 22 corresponds to a “third gear element” of the present invention.

Further, the oil pump 30 is disposed adjacent to the differential gear device 20 coaxially with the motor/generator MG1 and the differential gear device 20 (i.e. on the first axis). The oil pump 30 is a known gear pump which generates oil pressure by driving an oil pump gear mechanism (a drive gear, a driven gear, and a crescent) provided in a casing. The oil pressure generated by the oil pump 30 is used to lubricate the various parts of the driving apparatus (in particular, lubrication in the differential gear device 20) and to perform clutch operations. The oil pump 30 is connected to the input shaft 11, and the oil pump gear mechanism is activated to generate oil pressure by a rotary power transmitted from the input shaft 11. By disposing the oil pump 30 in the immediate vicinity of the differential gear device 20 in this manner, an oil passage constitution for supplying oil from the oil pump 30 to the differential gear device 20 is made extremely simple and short. Note that the oil pump 30 will be described in detail below.

Hence, in the driving apparatus according to the present embodiment, the motor/generator MG1, the differential gear device 20, the counter gear 25, and the oil pump 30 are disposed coaxially with the input shaft 11 in sequence from the engine side. In other words, the input shaft 11, motor/generator MG1, differential gear device 20, counter gear 25, and oil pump 30 are provided on the first axis.

Meanwhile, the motor/generator MG2 is disposed on a different axis (a second axis) parallel to the input shaft 11. The motor/generator MG2 is disposed on the opposite side of the gear mechanism 29 to the motor/generator MG1 in the axial direction. Furthermore, the motor/generator MG2 is disposed so as to overlap at least one of the first axis constitutional components in the radial direction. Note that the first axis constitutional components include not only the motor/generator MG1, differential gear device 20, counter gear 25, input shaft 11, and oil pump 30, but also components (bearings and the like) disposed on the first axis to form the driving apparatus and components required to dispose these components (cases of the various components, fixing members such as nuts, and so on). In the present embodiment, the first axis constitutional components that overlap the motor/generator MG2 in the radial direction are the motor/generator MG1, the differential gear device 20, the counter gear 25, the input shaft 11, the oil pump 30 (including the casing), a bearing 26 of the counter gear 25, a fixing member for the bearing 26, and so on. By arranging the motor/generator MG2 in this manner, the second axis can be brought close to the first axis, and therefore increases in the size of the driving apparatus in the radial direction occurring when the motor/generator MG2 is disposed on the second axis are minimized.

Similarly to the motor/generator MG1, the motor/generator MG2 functions as a motor driven by a power supply (a motoring function) and as a generator that converts mechanical energy into electrical energy (a regenerating function). The motor/generator MG2 operates mainly as a motor. An alternating current synchronous motor/generator, for example, may be used as the motor/generator MG2. A storage device such as a battery or a capacitor, a known fuel cell, for example, may be used as a power supply device. Note that the motor/generator MG2 according to the present embodiment corresponds to a “motor” of the present invention.

The motor/generator MG2 includes a stator 60 fixed to the transaxle case 80 to be described below, and a rotatable rotor 61. The stator 60 includes a stator core 62 and a coil 63 wound around the stator core 62. The rotor 61 and the stator core 62 are respectively formed by stacking a plurality of magnetic steel sheets of a predetermined thickness in a thickness direction. Note that the plurality of magnetic steel sheets are stacked in the axial direction. A rotor shaft 14 is disposed in the center of the rotor 61 such that the rotor 61 and the rotor shaft 14 are linked. The rotor shaft 14 is supported by bearings 64, 65. An output gear 66 is attached to an end portion of the rotor shaft 14. Thus, the rotor 61, the rotor shaft 14, and the output gear 66 rotate integrally. The output gear 66 meshes with the counter gear 25. Note that the rotor shaft 14 according to the present embodiment corresponds to a “rotary shaft of the motor” of the present invention, the bearings 64, 65 correspond to “motor bearings” of the present invention, and the bearing 64 corresponds to a “differential gear device side bearing” of the present invention.

The bearings 64, 65 supporting the rotor shaft 14 are disposed in a space on the outside of the rotor 61. As a result, the radial size of the motor/generator MG2 is reduced. The bearing 64 is disposed to overlap at least one of the first axis constitutional components in the axial direction. In the present embodiment, the bearing 64 is disposed to overlap the oil pump 30 in the axial direction.

Further, the rotor shaft 14 overlaps the motor/generator MG1 in the radial direction. The motor/generator MG1, the differential gear device 20, and the counter gear 25 are disposed on the first axis in order from the engine side, and therefore the motor/generator MG2 can be disposed close to the counter gear 25 and the rotor shaft 14 can be prevented from overlapping the motor/generator MG1, which has a large radial dimension, in the axial direction. As a result, the length of the rotor shaft 14 can be shortened, leading to cost reduction and reduction in the radial size of the driving apparatus.

By disposing the motor/generator MG2 on a different axis (the second axis) parallel to the input shaft 11 on the opposite side of the gear mechanism 29 to the motor/generator MG1 in this manner, rotation of the motor/generator MG2 can be reduced by the counter gear 25 and the output gear 66 without the use of a planetary gear. Therefore, a greater reduction ratio than that of a planetary gear can be set such that the motor/generator MG2 no longer requires high performance. As a result, the size and cost of the motor/generator MG2 is reduced. Further, the bearings 64, 65 of the motor/generator MG2 are disposed on the outside of the motor/generator MG2, and therefore the radial size of the motor/generator MG2 is further reduced. Moreover, a planetary gear is not used to reduce the rotation of the motor/generator MG2, and therefore the axial size and cost of the driving apparatus are reduced. Furthermore, the bearing 64 is disposed so as to overlap at least one of the first axis constitutional components in the axial direction, and therefore the axial length of the driving apparatus is not affected even when the bearings 64, 65 of the motor/generator MG2 are disposed on the outside of the motor/generator MG2.

Further, a counter shaft 15 is disposed on a different axis (a third axis) parallel to the input shaft 11. The counter shaft 15 is formed with a counter driven gear 70 and a final drive pinion gear 71. The counter driven gear 70 meshes with the counter gear 25, and the final drive pinion gear 71 meshes with a final ring gear 44 of the differential device 40.

Here, the counter gear 25 also meshes with the output gear 66 of the motor/generator MG2, as described above. In other words, the counter gear 25 meshes with both the output gear 66 and the counter driven gear 70. Hence, the counter gear 25 acts as both a reduction mechanism for the motor/generator MG2 and a gear mechanism for transmitting power from the input shaft 11 to the drive shaft 12.

The differential device 40 includes a plurality of pinion gears 42, a side gear 43 that meshes with the plurality of pinion gears 42, and the final ring gear 44 coupled to the plurality of pinion gears 42. The drive shaft 12 connected to the drive wheel is linked to the side gear 43 of the differential device 40.

As shown in FIG. 2, the respective constitutional components of the driving apparatus, disposed as described above, are accommodated in and fixed to the hollow transaxle case 80. The transaxle case 80 is attached to an outer wall of the engine. The transaxle case 80 includes an engine side housing 81, an extension housing 82, and an end cover 83. The engine side housing 81, extension housing 82, and end cover 83 are formed by molding a metallic material such as aluminum.

The engine side housing 81, the extension housing 82, and the end cover 83 are disposed in the transaxle case 80 in order from the engine side. The outer wall of the engine and the engine side housing 81 are fixed to each other such that an open end 84 on one end of the engine side housing 81 contacts the outer wall of the engine. Further, the engine side housing 81 and the extension housing 82 are fixed to each other such that an open end 85 on the other end of the engine side housing 81 contacts an open end 86 on one end of the extension housing 82. The end cover 83 is attached so as to close an open end 87 on the other end of the extension housing 82, whereby the end cover 83 and the extension housing 82 are fixed to each other.

The motor/generator MG1 is accommodated in and supported by the engine side housing 81, while the motor/generator MG2 is accommodated in and supported by the extension housing 82. In other words, the engine side housing 81 also serves as a case for the motor/generator MG1, while the extension housing 82 also serves as a case for the motor/generator MG2. Note that the extension housing 82 according to the present embodiment corresponds to a “motor case” of the present invention. Hence, the driving apparatus according to the present embodiment is constituted as a so-called transaxle in which the differential gear device 20 and the differential device 40 are incorporated collectively into the transaxle case 80.

Next, the arrangement and constitution of various components provided in the vicinity of the oil pump 30 will be described in detail with reference to FIG. 3. As shown in FIG. 3, the oil pump 30 includes an oil pump gear mechanism 31 disposed in an oil pump gear chamber 32, and an oil pump cover 33 that closes an opening of the oil pump gear chamber 32. The oil pump gear chamber 32 is formed on the inside of a first extension portion 82a formed by extending a part of the extension housing 82 in the axial direction toward the gear mechanism 29. Thus, the oil pump gear chamber 32 opens toward the gear mechanism 29. The oil pump cover 33 closing the opening of the oil pump gear chamber 32 is fixed to the extension housing 82 at a radial end portion by a tapered snap ring 34. Hence, a casing of the oil pump 30 is constituted by the first extension portion 82a and the oil pump cover 33.

By constituting the oil pump 30 in this manner, the motor/generator MG2 and the oil pump 30 can be disposed close to each other in the axial direction. Further, the oil pump cover 33 is fixed by the tapered snap ring 34, and therefore a bolt is not used to fix the oil pump cover, in contrast to a conventional driving apparatus. As a result, there is no need to secure space to dispose a bolt head, and therefore the oil pump 30 and the gear mechanism 29 can be disposed even closer to each other in the axial direction. Moreover, the oil pump gear chamber 32 is formed integrally with the extension housing 82, and therefore the number of components is reduced.

Here, the first extension portion 82a extends to the vicinity of a ring gear shaft 16 and an end portion of a boss portion 17 of the counter gear 25 so as to surround the periphery of the oil pump gear mechanism 31. The input shaft 11 penetrates the oil pump cover 33 such that a terminal end portion of the input shaft 11 is positioned within the oil pump gear chamber 32. The oil pump gear mechanism 31 is attached to the terminal end portion of the input shaft 11. Hence, in the oil pump 30, the rotation of the input shaft 11 is transmitted to the oil pump gear mechanism 31 such that oil in the oil pump gear chamber 32 can be pumped. Note that the oil pumped by the oil pump 30 is supplied to the differential gear device 20 and other constitutional components of the driving apparatus via an oil passage or the like formed in the input shaft 11.

Hence, the oil pump 30 is disposed on the terminal end portion of the input shaft 11 and driven by the rotation of the input shaft 11. Therefore, the need for a new mechanism to drive the oil pump 30 can be eliminated, thereby reducing the axial length of the first axis and therefore reducing the cost correspondingly. As a result, the axial size and cost of the driving apparatus can be further reduced.

Further, the oil pump 30 is disposed to overlap the motor/generator MG2 in the radial direction and to overlap the bearing 64 of the motor/generator MG2 in the axial direction. Hence, the axial length of the driving apparatus is not affected even when the bearings 64, 65 of the motor/generator MG2 are disposed on the outside of the motor/generator MG2.

Further, a second extension portion 82b is formed in the extension housing 82 as a continuation of the first extension portion 82a. The second extension portion 82b extends to a point immediately before a wheel surface 25a of the counter gear 25 so as to surround the boss portion 17 of the counter gear 25. The bearing 26 that supports the counter gear 25 is held by an inner peripheral surface 82c of the second extension portion 82b. Note that the bearing 26 is constituted by a bearing that restricts movement in both the axial direction and the radial direction, such as an angular contact bearing. With this constitution, the oil pump 30 and the counter gear 25 can be disposed close to each other in the axial direction. Further, a holding portion of the bearing 26 is formed integrally with the extension housing 82, and therefore the number of components is reduced. Note that the inner peripheral surface 82c according to the present embodiment corresponds to a “bearing holding portion” of the present invention.

Arrangement relationships between the various components provided in the driving apparatus according to the present embodiment will now be described with reference to FIG. 4. In FIG. 4, a side on which the input shaft 11 is disposed serves as a vehicle front side, and a side on which the drive shaft 12 is disposed serves as a vehicle rear side. As shown in FIG. 4, the rotor shaft 14 of the motor/generator MG2 is disposed to the rear of the input shaft 11, the counter shaft 15 is disposed to the rear of the rotor shaft 14, and the drive shaft 12 is disposed to the rear of the counter shaft 15. Further, the rotor shaft 14 is disposed above the input shaft 11, while the counter shaft 15 and the drive shaft 12 are disposed below the input shaft 11. Note that the counter shaft 15 is disposed below the drive shaft 12. In other words, the rotor shaft 14 is disposed so as to be positioned between the input shaft 11 and the drive shaft 12 and above the input shaft 11. With this shaft arrangement, the motor/generator MG2 provided on a different axis from the input shaft 11 can be disposed in an empty space existing between the input shaft 11 and the drive shaft 12, and therefore the radial size of the driving apparatus can be reduced. Moreover, reduction in a minimum ground clearance of the vehicle can be prevented.

The driving apparatus constituted as described above is controlled by an electronic control device that controls the entire vehicle. More specifically, a signal from an ignition switch, a signal from an engine speed sensor, a signal from a brake switch, a signal from a vehicle speed sensor, a signal from an accelerator opening sensor, a signal from a shift position sensor, a signal from a resolver that detects the respective rotation speeds of the motor/generators MG1, MG2, and so on are input into the electronic control device. On the basis of these signals, the electronic control device calculates required torque to be transmitted to the drive shaft 12. On the basis of the calculation result, signals for controlling an intake air amount, a fuel injection amount, and an ignition timing of the engine, signals for controlling outputs of the motor/generators MG1, MG2, and so on are output from the electronic control device to the respective portions, whereby an overall operation of the driving apparatus is controlled.

More specifically, when power (torque) output from the engine is to be transmitted to the drive shaft 12, the torque of the engine is transmitted to the planetary carrier 24 via the input shaft 11. The torque transmitted to the planetary carrier 24 is then transmitted to the drive shaft 12 via the ring gear 22, the counter gear 25, the counter driven gear 70, the counter shaft 15, the final drive pinion gear 71, and the differential device 40, whereby a driving force is generated.

When the torque of the engine is transmitted to the planetary carrier 24 at this time, the motor/generator MG1 functions as a generator such that power generated by the motor/generator MG1 is charged to the storage device (not shown).

On the other hand, when the motor/generator MG2 is driven as a motor such that the power thereof is transmitted to the drive shaft 12, the power (torque) of the motor/generator MG2 is transmitted to the output gear 66 via the rotor shaft 14, and the rotation of the output gear 66 is reduced and then transmitted to the counter gear 25. This reduced rotation is then synthesized with the torque of the engine by the counter gear 25, and the resulting synthesized torque is transmitted to the drive shaft 12 via the counter driven gear 70, the counter shaft 15, the final drive pinion gear 71, and the differential device 40 to generate a driving force.

Hence, in the driving apparatus according to the present embodiment, the motor/generator MG2 is disposed on a different axis parallel to the input shaft 11 on the opposite side of the gear mechanism 29 to the motor/generator MG1 in the axial direction, and therefore the rotation of the motor/generator MG2 can be reduced by the counter gear 25 and the output gear 66 without using a planetary gear. As a result, the reduction ratio can be made larger than that of a planetary gear, and therefore high performance is no longer required of the motor/generator MG2. Accordingly, the size and cost of the motor/generator MG2 can be reduced. Further, the bearings 64, 65 of the motor/generator MG2 are disposed on the outside of the motor/generator MG2, and therefore the radial size of the motor/generator MG2 can also be reduced. Thus, increases in the radial size of the driving apparatus occurring when the motor/generator MG2 is provided on a different axis from the input shaft 11 can be minimized. Moreover, a planetary gear is not used to reduce the rotation of the motor/generator MG2, and therefore the axial size and cost of the driving apparatus can be reduced.

The oil pump 30, which is one of the first axis constitutional components, is disposed to overlap the motor/generator MG2 in the radial direction and overlap the bearing 64 disposed on the outside of the motor/generator MG2 in the axial direction. Therefore, the axial length of the driving apparatus is not affected even when the bearings 64, 65 of the motor/generator MG2 are disposed on the outside of the motor/generator MG2, and as a result, the axial size of the driving apparatus can be sufficiently reduced as described above.

Further, by making the rotor shaft 14 of the motor/generator MG2 overlap the motor/generator MG1 in the radial direction, the motor/generator MG2 can be disposed close to the counter gear 25, and the rotor shaft 14 is prevented from overlapping the motor/generator MG1 in the axial direction. Therefore, the length of the rotor shaft 14 can be shortened, thereby reducing the cost, and the radial size of the driving apparatus can be reduced.

Further, the oil pump 30 is disposed on the terminal end portion of the input shaft 11 so as to be driven directly by the rotation of the input shaft 11, and therefore a new mechanism for driving the oil pump 30 becomes unnecessary, thereby reducing the axial length of the first axis and the cost correspondingly. Hence, the axial size of the driving apparatus can further be reduced, thereby further reducing the cost. Furthermore, the oil pump 30 is disposed in the immediate vicinity of the differential gear device 20, and therefore the constitution of an oil passage for supplying oil from the oil pump 30 to the differential gear device 20 can be made extremely simple and short. As a result, the number of processing steps required to provide the oil passage in the driving apparatus can be reduced, which contributes to cost reduction of the driving apparatus.

Further, a part of the extension housing 82 that accommodates and supports the motor/generator MG2 extends toward the gear mechanism 29 to form the first extension portion 82a and the second extension portion 82b forming a continuation of the first extension portion 82a. The gear chamber 32 of the oil pump 30 is provided on the inside of the first extension portion 82a, and the bearing 26 of the counter gear 25 is held by the inner peripheral surface 82c of the second extension portion 82b. As a result, the motor/generator MG2 and oil pump 30 can be brought closer together in the axial direction, and the oil pump 30 and counter gear 25 can be brought closer together in the axial direction. Moreover, the oil pump gear chamber 32 and the holding portion of the bearing 26 can be formed integrally in the extension housing 82, and therefore the number of components can be reduced. Accordingly, the axial size of the driving apparatus can be reduced even further, thereby further reducing the cost of the driving apparatus.

Furthermore, the oil pump cover 33 that closes the opening in the gear chamber 32 of the oil pump 30 is fixed to the extension housing 82 by the tapered snap ring 34, and therefore, in contrast to a conventional driving apparatus, there is no need to secure space to dispose a bolt head of a bolt for fixing the oil pump cover. Hence, the oil pump 30 and the gear mechanism 29 can be disposed close to each other in the axial direction, which contributes to reduction in the size of the driving apparatus.

According to the driving apparatus of the present embodiment, as described in detail above, the motor/generator MG1, differential gear device 20, counter gear 25, and oil pump 30 are disposed coaxially with the input shaft 11 in this order from the engine side, while the motor/generator MG2 is disposed on a different axis parallel to the input shaft 11 on the opposite side of the gear mechanism 29 to the motor/generator MG1 in the axial direction and the bearings 64, 65 of the motor/generator MG2 are disposed on the outside of the motor/generator MG2. Further, the oil pump 30, which is one of the first axis constitutional components, is disposed to overlap the motor/generator MG2 in the radial direction and overlap the bearing 64 of the motor/generator MG2 that is positioned on the gear mechanism 29 side in the axial direction. Therefore, the size and cost of the motor/generator MG2 can be reduced, the rotation of the motor/generator MG2 can be reduced without using a planetary gear, and the number of processing steps required to provide the oil passage can be reduced. Accordingly, the overall size of the driving apparatus can be reduced, and the cost of the driving apparatus can also be reduced.

Note that the embodiment described above is merely an example which does not limit the present invention in any way, and various amendments and modifications may be applied within a scope of the present invention without departing from the spirit of the present invention. For example, in the above embodiment, an example in which the present invention is applied to a transverse driving apparatus installed in a front engine/front drive (FF) vehicle has been described, but the present invention may also be applied to a transverse driving apparatus installed in a rear engine/rear drive (RR) vehicle.

Further, in the above embodiment, the gear that meshes with the output gear 66 of the motor/generator MG2 and the gear that transmits power to the drive shaft 12 are shared (i.e. a single counter gear is used), but the respective gears may be provided separately (i.e. two counter gears may be provided).

1. A driving apparatus for a hybrid vehicle, comprising:
an input shaft linked to an engine;
a generator;
a motor;
a differential gear device including a first gear element linked to a rotary shaft of the generator, a second gear element linked to the input shaft, and a third gear element that transmits power to a drive shaft; and
a counter gear that is linked to the third gear element of the differential gear device and drive-linked to the motor, wherein
the generator, the differential gear device, and the counter gear are disposed coaxially with the input shaft,
the motor is disposed on a different axis parallel to the input shaft on an opposite side of the generator, the differential gear device, and the counter gear to an engine-linked side of the input shaft in an axial direction,
motor bearings for rotatably supporting a rotary shaft of the motor are disposed on an outer side of the motor,
the motor is disposed to overlap at least one of first axis constitutional components disposed coaxially with the input shaft in a radial direction, and
a differential gear device side bearing of the motor bearings, which is positioned on the differential gear device side, is disposed to overlap at least one of the first axis constitutional components in the axial direction.

2. The driving apparatus for a hybrid vehicle according to claim 1, wherein
the generator, the differential gear device, and the counter gear are disposed coaxially with the input shaft in this order from the engine-linked side of the input shaft, and
an output shaft of the motor overlaps the generator in the radial direction.

3. The driving apparatus for a hybrid vehicle according to claim 1, wherein one of the first axis constitutional components that overlaps the motor bearings in the axial direction is an oil pump.

4. The driving apparatus for a hybrid vehicle according to claim 3, wherein the generator, the differential gear device, the counter gear, and the oil pump are disposed coaxially with the input shaft in this order from the engine-linked side of the input shaft.

5. The driving apparatus for a hybrid vehicle according to claim 4, wherein the oil pump is disposed on a terminal end portion of the input shaft and driven by a rotation of the input shaft.

6. The driving apparatus for a hybrid vehicle according to claim 4, wherein
the drive shaft is disposed parallel to the input shaft,
an output gear of the motor meshes with the counter gear,
the counter gear is disposed parallel to the input shaft so as to mesh with a counter driven gear of a counter shaft that transmits power to the drive shaft, and
a final drive pinion gear of the counter shaft meshes with a final ring gear of a differential device that transmits power to the drive shaft.

7. The driving apparatus for a hybrid vehicle according to claim 4, wherein an oil pump gear chamber that accommodates an oil pump gear mechanism provided in the oil pump is formed integrally with a motor case that accommodates and supports the motor.

8. The driving apparatus for a hybrid vehicle according to claim 7, wherein the oil pump gear chamber is provided in a first extension portion extending such that the motor case partially surrounds the oil pump gear mechanism.

9. The driving apparatus for a hybrid vehicle according to claim 7, wherein an oil pump cover that closes an opening in the oil pump gear chamber is fixed to the motor case by a snap ring.

10. The driving apparatus for a hybrid vehicle according to claim 3, wherein a bearing holding portion for holding a counter gear bearing that rotatably supports the counter gear is formed integrally with the motor case that accommodates and supports the motor.

11. The driving apparatus for a hybrid vehicle according to claim 10, wherein the bearing holding portion is provided in a second extension portion formed to further extend from the first extension portion, which extends such that the motor case partially surrounds the oil pump gear mechanism provided in the oil pump, so as to surround a boss portion of the counter gear.

12. The driving apparatus for a hybrid vehicle according to claim 1, wherein in a vehicle installed state, the motor is disposed such that the rotary shaft of the motor is positioned between the input shaft and the drive shaft in a vehicle front-rear direction and above the input shaft.

13. The driving apparatus for a hybrid vehicle according to claim 2, wherein one of the first axis constitutional components that overlaps the motor bearings in the axial direction is an oil pump.

14. The driving apparatus for a hybrid vehicle according to claim 13, wherein the generator, the differential gear device, the counter gear, and the oil pump are disposed coaxially with the input shaft in this order from the engine-linked side of the input shaft.

15. The driving apparatus for a hybrid vehicle according to claim 14, wherein the oil pump is disposed on a terminal end portion of the input shaft and driven by a rotation of the input shaft.

16. The driving apparatus for a hybrid vehicle according to claim 15, wherein
the drive shaft is disposed parallel to the input shaft,
an output gear of the motor meshes with the counter gear,
the counter gear is disposed parallel to the input shaft so as to mesh with a counter driven gear of a counter shaft that transmits power to the drive shaft, and
a final drive pinion gear of the counter shaft meshes with a final ring gear of a differential device that transmits power to the drive shaft.

17. The driving apparatus for a hybrid vehicle according to claim 16, wherein an oil pump gear chamber that accommodates an oil pump gear mechanism provided in the oil pump is formed integrally with a motor case that accommodates and supports the motor.

18. The driving apparatus for a hybrid vehicle according to claim 17, wherein the oil pump gear chamber is provided in a first extension portion extending such that the motor case partially surrounds the oil pump gear mechanism.

19. The driving apparatus for a hybrid vehicle according to claim 18, wherein an oil pump cover that closes an Opening in the oil pump gear chamber is fixed to the motor case by a snap ring.

20. The driving apparatus for a hybrid vehicle according to claim 3, wherein in a vehicle installed state, the motor is disposed such that the rotary shaft of the motor is positioned between the input shaft and the drive shaft in a vehicle front-rear direction and above the input shaft.
